(19) United States
(12) Patent Application Publication
(10) Pub. No.: US 2011/0219021 A1
(43) Pub. Date: Sep. 8, 2011

(54) Systems and methods for improved search term entry

(76) Inventor: Jason M. Litowitz, Tabernacle, NJ (US)

(21) Appl. No.: 12/932,595

(22) Filed: Mar. 1, 2011

Related U.S. Application Data
(60) Provisional application No. 61/339,225, filed on Mar. 2, 2010.

(51) Int. Cl. G06F 17/30

(52) U.S. Cl. 707/769; 707/E17.016

(57) ABSTRACT

Systems and methods for improved ways of entering search criteria are disclosed. The system includes a user-facing entry component for receiving search criteria, a database of predefined search criteria, a search engine, and a feedback component.

### CROSS-REFERENCE TO RELATED APPLICATIONS

This patent claims priority to provisional patent 61/339,225, filing date Mar. 2, 2010.

### STATEMENT REGARDING FEDERALLY SPONSORED RESEARCH OR DEVELOPMENT

Not Applicable

### BACKGROUND OF THE INVENTION

From the user perspective, most computerized search engines operate the same basic way: the user enters search terms as text, which the search system uses to generate a result list. The search engine may search for the exact term, it may search for any or all of the words, and it may even allow the user to use Boolean (“X and Y”, “A or B”) and other operators (“X within 3 words of Y”, “A within the same paragraph as B”) to further control the search.

The quality of the search results depends in part on the search terms entered by the user. For simplistic searches, this is not a problem. For example, a user looking up the definition of a single word in a computerized dictionary only cares about the single word, and need only enter that one word.

For more complicated searches, determining the most useful keywords may prove problematic. For example, a user may remember the general storyline of a book she read as a child, but cannot remember the author, the title, or the names of any of the characters or significant locations in the book. A user facing such a situation would have great difficulty using a computerized search engine to identify the book she once read. A user trying to remember the name of a childhood book needs a way to enter “There was a boy who was in love with a girl who was in love with another boy who was in the military in a far away land.”

Such complicated searches are rampant, for example, in the legal field, where attorneys attempt to find case law to support their client. Sometimes a little known case may apply a legal theory in a non-traditional way, and that could be the linchpin that wins the case for their client—if they can locate such a case. A lawyer in such a situation needs a way to enter “Plaintiff sued Defendant for doing X, but Defendant claims Plaintiff did Y to a third party.”

What is needed is a way to search documents based on the content, using a search entry system based not exclusively on keywords.

### BRIEF SUMMARY OF THE INVENTION

A user uses graphical elements to define the search criteria. Nodes represent people, places, or objects. Connectors represent relationships between the Nodes. Multiple Nodes and Connectors may be grouped into a reusable Group.

Sources represent sources of data, such as fictional literature, New Jersey case law, or Haikus written in France. Filters may be used to restrict searches to a subset of a Source. Filters may perform many different abilities, including providing the capability to enter keyword searches. Filters may operate on the content of the data, such as looking for particular keywords, or may operate on meta-data that describes the data. For example, in the case of the Source Haikus written in France, a Filter may operate on the meta-data to filter the complete group of Haikus down to those written in Paris.

The user can modify properties of the Nodes, Connectors, Sources, and Filters to define her search. When the user is satisfied with her search criteria (the “Query”), the Query is submitted to the search engine. The search engine examines the Query, and accesses the subset(s) of the Sources that fulfill the criteria determined by the Filters. Relationships identified as associated with those subset(s) are compared with the relationships defined by the Nodes and Connectors, and a results list is generated.

User conduct can then be analyzed to improve future searches. Explicit feedback mechanisms (where the user affirmatively indicates that the result was what she wanted, or that the result was what she did not want) may be employed. Alternative mechanisms, such as tracking which results the user accesses from the result list, can be used to generate an association between the Query and the selected result(s). The Query can then be added to the database of predefined search criteria, and used in future searches.

### BRIEF DESCRIPTION OF THE DRAWINGS

1. A data source representation, consisting of a Source, a Filter, and resulting in a DataSet.
2. A data source representation, consisting of a Source, a Filter, optional additional Filters, resulting in a DataSet.
3. A data source representation, consisting of a Source, two Filters, resulting in a DataSet.
4. A Source, and one or more Filters, grouped as a SuperSource.
5. A data source representation, consisting of two Sources, a Filter, and resulting in a DataSet.
6. Three Filters, grouped as a SuperFilter.
7. An example of a Filter which is simply a keyword entry box.
8. An example of a Filter which is a series of checkboxes.
9. An example of an arbitrarily complex Filter which is a series of checkboxes, radio buttons, and a keyword entry box.
10. A sample screenshot showing the Data Source Manager on the left and the Relationship Manager on the right.
11. A sample screenshot showing the Relationship Manager displayed “on top of” the Data Source. The Data Source Manager is activated by selecting the Source button in the corner.

### DETAILED DESCRIPTION OF THE INVENTION

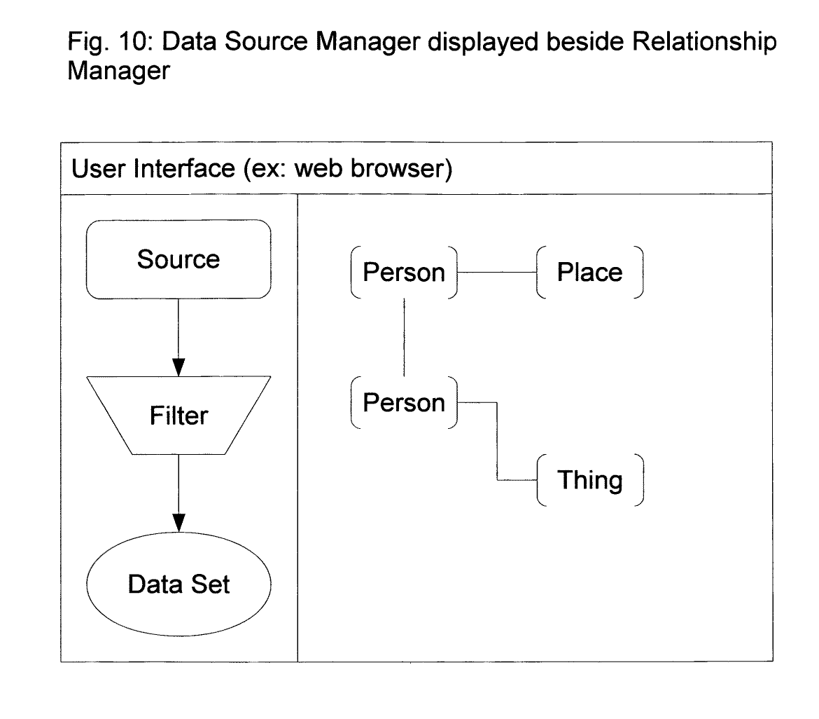

As best seen in FIG. 10, when performing a search, a user will define the DataSet to search, and define elements and relationships between those elements (the “Query”). Preferably these definitions and relationships are performed using a visual editor, similar in feel Microsoft Visio and similar programs. The user interface may be developed in any appropriate manner. Preferably, the visual editor would run within a piece of standard software on the client computer, such as a web browser, and be written in a standard software environment such as Java, Flash, or DHTML. In another preferred embodiment, a user interface runs outside of a web browser, preferably as either an executable that runs natively on the client computer, or is compiled as a more neutral format such as Java, .NET, or Mono.

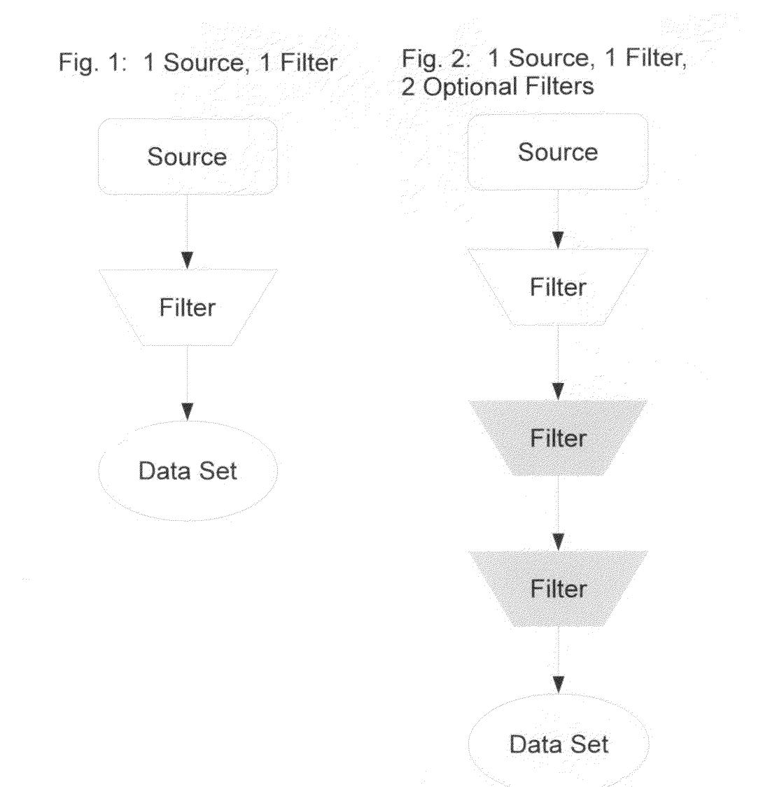

Referring to FIG. 1, a Source node is used to indicate a set of documents to search. Each document has one or more assigned relationship diagrams assigned to it, preferably with a weighting metric assigned that identifies how strongly the assigned relationship diagram identifies the document.

The set of documents in a Source node can be as narrow or as broad of a set of documents as the search engine allows. For example, an implementation for the legal field may have a relatively narrow Source node representing “All Reported Case Law from the Southern District of New York” as one Source node, or the very broad “All Reported Case Law” as another. A Source node need not be tied to a single, specific database, but instead is representative of a grouping of documents that share some common trait. In the previous two examples, all reported case law from the Southern District of New York, and all reported case law, respectively. As will be described further below, multiple other Source nodes can be grouped together into a single SuperSource node.

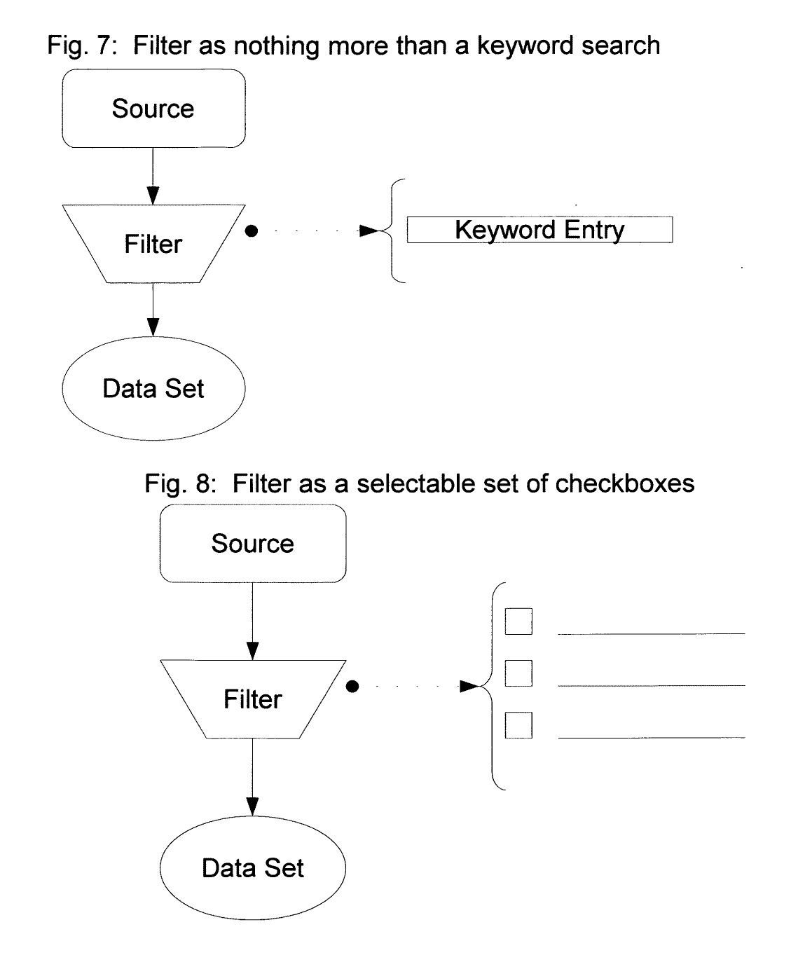

The output of the Source node is passed into a Filter node. A Filter node is used to perform some initial culling of the data within the Source node, to include only those documents that the user thinks may be of interest. A Filter can be arbitrarily simple or complex, as determined by the search engine. For example, as seen in FIG. 7, a Filter node can be simply a keyword search entry. In this case, the Filter node will exclude any documents that do not include the keyword(s) indicated. More complex keyword searches are also possible, including Boolean logic, searching for any of the words specified, requiring all of the words specified, or any other arbitrarily complex keyword search functionalities, such as proximity (find word X within 3 words of word Y; find word Z within the same paragraph as A; etc.), regular expressions, or any other text-based search mechanism.

Now referring to FIG. 8, a Filter node need not be a keyword search entry box. It may, for example, be a set of checkboxes which the user may select to indicate certain criteria about the documents. In the case of searching the universe of children's story books, the checkboxes may be used to allow the user to search for books only by male authors, female authors, or both; the checkboxes may be used to allow the user to search for books written by authors from one or more specific countries; or the checkboxes may be used to allow the user to search for books which have translations into one or more languages.

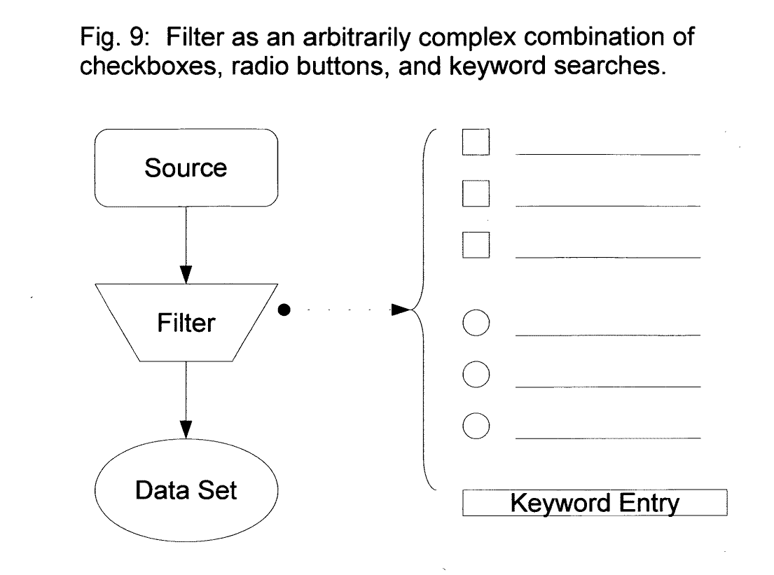

The complexity of a Filter node is in fact arbitrary. By way of example only, as shown in FIG. 9, a Filter node may be a set of checkboxes to represent one or more non-exclusive options, a set of radiobuttons to represent a set of exclusive options, and a keyword search entry box.

Referring back to FIG. 1, the output of a Filter node is sent to a DataSet node. The DataSet node represents the subset of documents that exist in the Source node, and match the criteria of the Filter node. Preferably there would be only one DataSet node, though a source relationship diagram may allow for multiple DataSet nodes.

In the case of multiple DataSet nodes, in a preferred embodiment the search engine will search through the union of the two DataSet nodes. In another preferred embodiment, the search engine will only search through the intersection of documents in the two DataSet nodes. In another preferred embodiment, the search engine will only search through documents that exist in one DataSet node but not in the other DataSet node.

Now referring to FIG. 2, the output of one Filter node may be passed to a second Filter node. The output of the second Filter node may be passed to a third Filter node. An arbitrary number of Filter nodes may be chained in this fashion. The output of the last Filter node is passed to the DataSet node. In this fashion, the DataSet node represents those documents that pass through each and every Filter node.

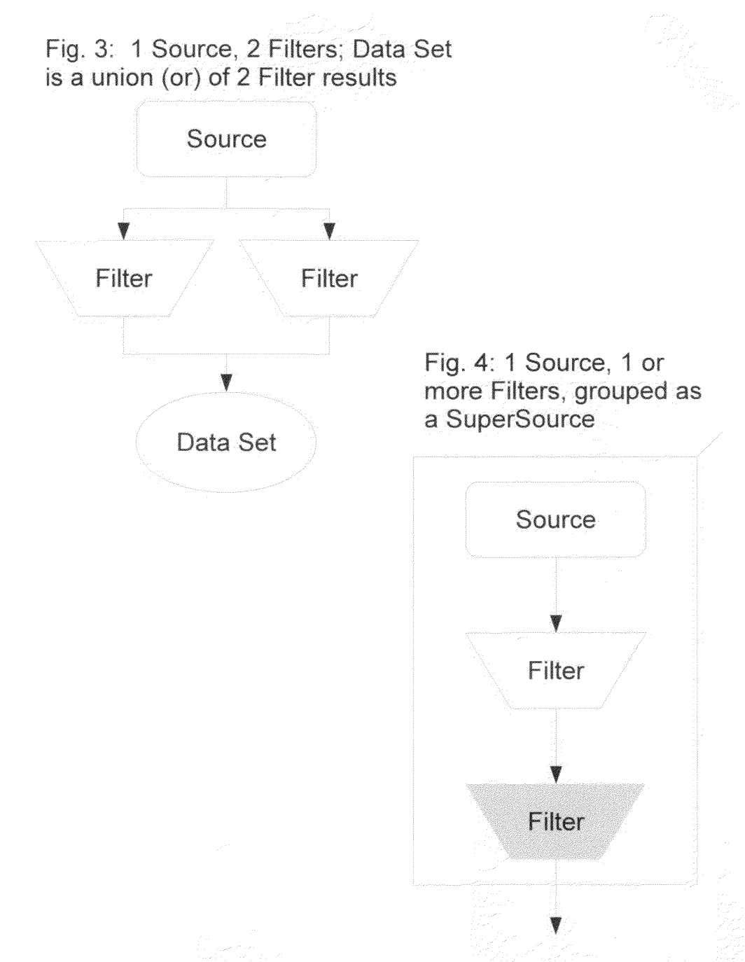

Now referring to FIG. 3, the output of the Source node may be passed to two separate Filter nodes. The output of the two Filter nodes are each passed to the single DataSet node. In this case, the DataSet node represents the union of the documents that are allowed by each of the two Filter nodes.

Now referring to FIG. 4, a Source node and an arbitrary number of Filter nodes may be grouped together into a SuperSource node. The SuperSource node may be reused and treated like any other Source node in other source relationship diagrams. For example, if a Source node that represents “fictional literature” is filtered by a Filter that allows only “sci-fi” documents through, those two nodes may be grouped into a “sci-fi literature” SuperSource node for future re-use.

When reused, the SuperSource nodes function just like any other Source node: they may be connected to one or more Filter nodes, and/or may be grouped into even larger SuperSource nodes. The SuperSource nodes may be configured such that the user is entirely unaware that they are using a SuperSource node instead of a Source node. The SuperSource nodes may alternatively be configured such that the user may be able to view the internal grouping structure of a SuperSource node, but be unable to modify it. The SuperSource node may even be configured to be editable by the user. In the case where a user is able to edit the SuperSource node, the SuperSource node may be editable in-place, the SuperSource node may be copied to a new SuperSource node that the user edits, or the contents of the SuperSource node are copied directly into the source relationship manager which the user may then edit.

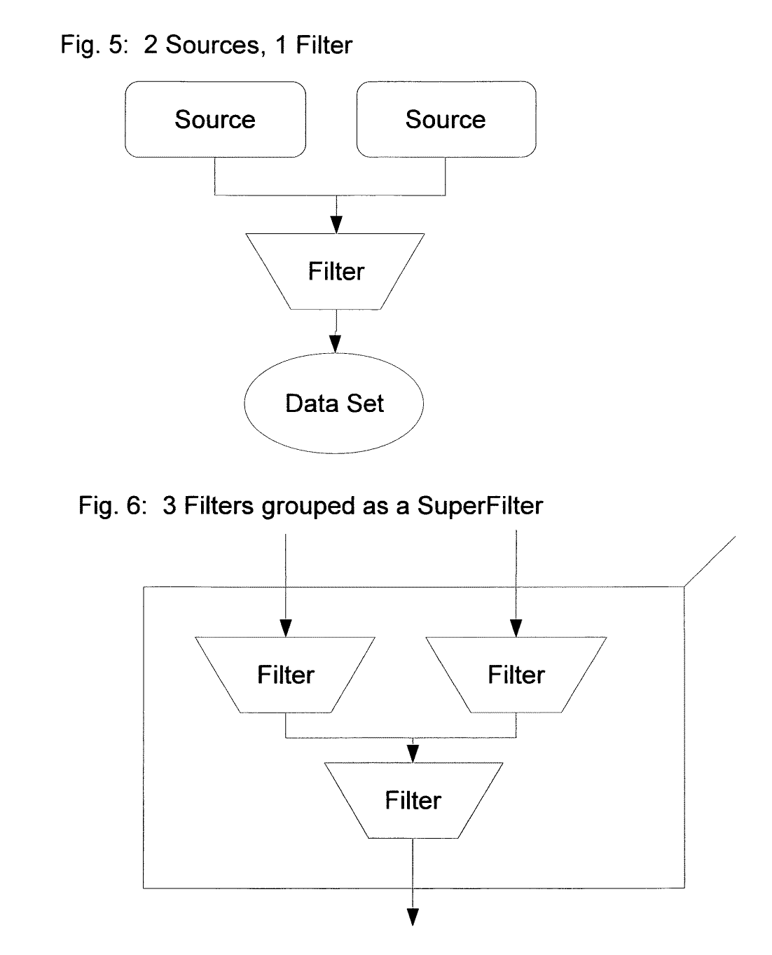

Now referring to FIG. 5, a Filter node may operate on documents stored in two or more Source nodes. Preferably, the Filter node will operate on a union of all documents. However, Filter nodes may be also be configured so as to perform some basic set logic on the multiple Source nodes, including operations such as intersection (only those documents that appear in both Source nodes) and exclusive or (only those documents that appear in one or the other Source nodes, but not both).

Now referring to FIG. 6, multiple Filter nodes may be grouped together into a SuperFilter node. Just as with the SuperSource nodes, a SuperFilter node may be stored for later reuse, and its inner structure may or may not be made available for review or editing by a later user. When used in the place of a Filter node, a SuperFilter node will operate transparently to the user, not necessarily giving any indication that it is a SuperFilter instead of a Filter node.

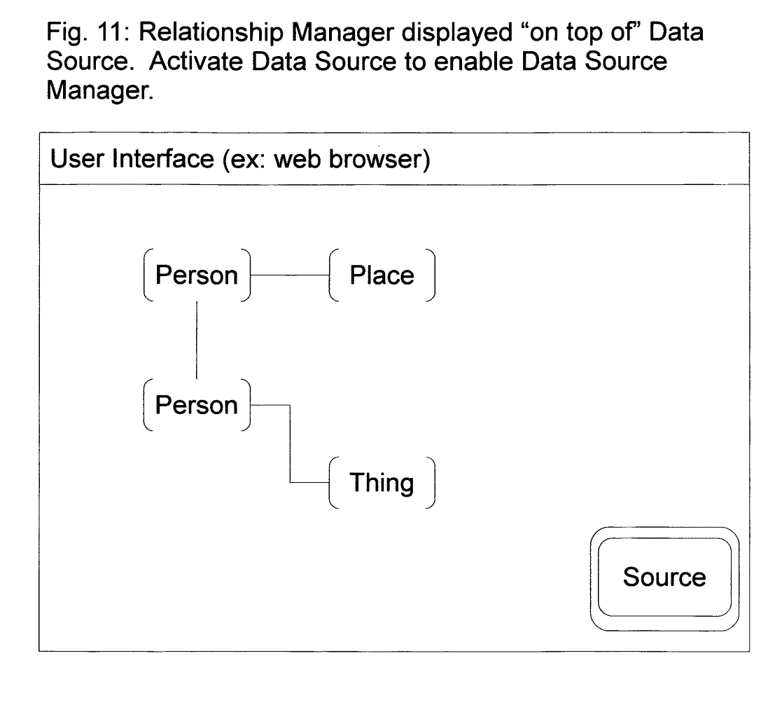

Now referring to FIGS. 10 and 11, sample mock-ups of screenshots are shown. In the preferred embodiment shown in FIG. 10, the Data Source Manager is displayed alongside the Relationship Manager described in further detail below. In another preferred embodiment as shown in FIG. 11, the Relationship Manager takes up a larger portion of the application interface; access to the Data Source Manager is provided by activating a user interface element such as a link, menu choice, or as shown in FIG. 11, a button.

The Relationship Manager allows the user to define entities (Object nodes) and their relationships (Connections) between them. Preferably, each Object node represents a noun—typically a person, place or thing. Each Object node may have various attributes assigned to it. For example, an Object node may represent a person; attributes of the Object may indicate that the person is a child, and another attribute may indicate that the person is a boy. Another Object node may represent another person; attributes of this other Object node may indicate that the person is an adult, and another attribute may indicate that the person is a woman.

A Connection, preferably visibly displayed as a connecting line, may be established between two Object nodes. Attributes of the Connection may be used to identify the relationship between the two Object nodes. For example, attributes of a Connection may be used to indicate that a woman is the mother of a boy. In a preferred embodiment, Connections are unidirectional. In the example where a Connection indicates that a woman is the mother of a boy, it does not also indicate that the boy is the son of the mother. In another preferred embodiment, Connections are bidirectional. In the example where a Connection indicates that a woman is the mother of a boy, it also indicates that the boy is the son of the woman.

A Connection between Objects can be used to indicate not just familial relationships, but event relationships. That is, a Connection may be used to indicate a shared event between two people, such as, Person 1 once saved the life of Person 2. In the case of a user performing legal research, a Connection may be drawn between two Object nodes to represent a theory of law that was applied, such as, a claim under respondeat superior by a patron against the employer of a bouncer at a night club.

Groups of Object nodes and their Connections may be grouped into a SuperObject for later reuse. As with SuperFilters and SuperGroups, SuperObjects may be used transparently by the user, the structure of the SuperObject may be visible by the user, or the structure of the SuperObject may be editable, either in-place or as a new copy, by the user.

Once the user has defined the Source node(s), Filter node(s), Object node(s), and Connections, the user instructs the system to perform a search. The system compares the relationships defined in the Relationship Manager to the assigned relationship diagrams associated with the documents in the DataSet (the documents from the Source node(s) that pass through the Filter node(s)). If any SuperObject nodes are used, they will preferably be replaced with their representative innards to reduce the number of comparisons—otherwise, as the number of SuperObjects in a Query grows, the number of possible comparisons that must be run may grows substantially, as searches for each SuperObject and its innards must be run against the DataSet.

The comparison mechanism can be any appropriate comparator. Preferably, each assigned relationship associated with a given document has a weighting metric. If a particular search results in two documents, the document whose relationship has a greater weight will be ranked higher in the search results. Prior to ranking the search results, the weighting metric may be adjusted, as described below.

The mechanism used to represent the Objects can be any appropriate scheme. A preferred mechanism is to represent each Object as follows:

ObjectID

ObjectType

Attribute 1

Attribute 2

. . .

Attribute N

The ObjectID is an identifier unique to the particular Query. The ObectType defines what type of object the Object node represents; for example, it could represent a person or a place. Attribute 1-N represent the attributes specified by the user for that Object node.

The mechanism used to represent the Connections can be any appropriate scheme. A preferred mechanism is to represent each Connection as follows:

ConnectionID

ObjectID1

ObjectID2

Attribute 1

Attribute 2

. . .

Attribute M

The ConnectionID is an identifier unique to the particular Query. ObjectID1 and ObjectID2 are the respective ObjectIDs of the Object nodes that the Connection connects. Attribute 1-M represent the attributes specified by the user for that Connection.

This collection of Object node data and Connection data is used to identify documents in the DataSet that have a similar relationship diagram assigned to it. As previously mentioned, an assigned relationship diagram will preferably have a weighting metric assigned to it. Preferably, when generating the result list, the search engine will also account for the relative percentage of the assigned relationship diagram that corresponds with the Query. For example, an identified assigned relationship diagram may have a weighting metric of 7 applied to it, while the Query overlaps 50% of the assigned relationship diagram. The two values of 7 and 50% are multiplied together, for a value of 3.5. This value of 3.5 is used to rank the return list in likelihood of relevance for the user.

After the list of matches is compiled, the list is provided to the user. If there are many matches, the result list may be displayed in sections (such as possibly 10 or 20) at a time, and allows the user to page through the results.

When the user selects one document from the search result list, the user may be prompted to indicate the user's opinion on how strongly the Query applies to the document. If the user indicates that the Query is very appropriate, the Query may be stored in the system as a new assigned relationship diagram, with a high weight factor given to it. Alternatively, if a very similar or identical Query already exists in the system as an assigned relationship diagram, the weight factor may be increased. If, on the other hand, the user indicates that the Query does not adequately describe the selected document, the Query may be stored in the system as an assigned relationship diagram with a low weight factor given to it, or alternatively, if a very similar or identical assigned relationship diagram already exists in the system, the weight factor associated with the document may be decreased. In this way, user feedback may help improve future searches.

1) A method for searching data comprising:
Providing a search entry interface;
Converting data entered in said search entry interface into a map;
Comparing said map to stored maps in a first source set;
And identifying documents associated with said maps.

2) The method of claim 1, wherein said data entered comprises a first object, a second object, and a connection between said first object and said second object.

3) The method of claim 2, wherein said comparing step comprises: comparing said map to a subset of said stored maps in said first source set, where said subset comprises said stored maps in said first source set that match a provided criteria.

4) The method of claim 2, further comprising: providing a second source set comprising stored maps; and comparing said map to said stored maps in said second source set.

5) The method of claim 2, further comprising: providing a second source set comprising stored maps; and where said comparing step further comprises: comparing said map to a union of at least a subset of said stored maps in said first source set and at least a subset of said stored maps in said second source set.

6) The method of claim 2, further comprising: associating at least one of said identified documents with said map; and adding said map to said first source set.

7) The method of claim 2, further comprising: adjusting the strength of the association between a stored map in said first source set and a document associated with said stored map.

8) A system for searching data implementing the method of claim 2.
